(19) United States
(12) Patent Application Publication
(10) Pub. No.: US 2022/0262138 A1
(43) Pub. Date: Aug. 18, 2022

(54) DIVISION LINE RECOGNITION APPARATUS

(71) Applicant: Honda Motor Co., Ltd., Tokyo (JP)

(72) Inventor: Yuichi Konishi, Wako-shi (JP)

(21) Appl. No.: 17/669,340

(22) Filed: Feb. 10, 2022

(30) Foreign Application Priority Data
Feb. 15, 2021 (JP) 2021-021492

(51) Int. Cl. G06V 20/56; B60W 40/06; B60W 40/105; B60W 40/114; G01C 21/00

(52) U.S. Cl. CPC G06V 20/588; B60W 40/06; B60W 40/105; B60W 40/114; B60W 2552/53; G01C 21/3837; B60W 2420/42; B60W 2520/14; G01C 21/3815

(57) ABSTRACT

A division line recognition apparatus including a detection part configured to detect an external situation around a subject vehicle, and an electronic control unit including a microprocessor and a memory connected to the microprocessor. The microprocessor is configured to perform recognizing a linear figure on a road surface based on the external situation detected by the detection part, and determining whether the linear figure is a division line defining a lane based on a continuity of the linear figure recognized.

### CROSS-REFERENCE TO RELATED APPLICATION

This application is based upon and claims the benefit of priority from Japanese Patent Application No. 2021-021492 filed on Feb. 15, 2021, the content of which is incorporated herein by reference.

### BACKGROUND OF THE INVENTION

### Field of the Invention

This invention relates to a division line recognition apparatus configured to recognize a division line on a road.

### Description of the Related Art

As this type of apparatus, conventionally, there is a known apparatus in which white lines of a lane and a parking lot frame are recognized using an image captured by a camera mounted on a vehicle, and the recognition results of the white lines are used for vehicle driving control and parking support. Such an apparatus is described, for example, in Japanese Unexamined Patent Publication No. 2014-104853 (JP2014-104853A). In the apparatus disclosed in JP2014-104853A, edge points at which a change in luminance in the captured image is equal to or greater than a threshold is extracted, and the white lines are recognized based on the edge points.

However, when the white line is recognized as in the apparatus described in JP2014-104853A, there is a possibility that, for example, a crack and an old white line are erroneously recognized as a white line if there is such a crack on a road surface or the old white line remains on the road surface after the white line is redrawn.

### SUMMARY OF THE INVENTION

An aspect of the present invention is a division line recognition apparatus, including a detection part configured to detect an external situation around a subject vehicle, and an electronic control unit including a microprocessor and a memory connected to the microprocessor. The microprocessor is configured to perform: recognizing a linear figure on a road surface, based on the external situation detected by the detection part; and determining whether the linear figure is a division line defining a lane, based on a continuity of the linear figure recognized.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system having a division line recognition apparatus according to an embodiment of the present invention;

FIG. 2A is a view illustrating an example of a traveling scene to which the division line recognition apparatus according to the embodiment of the invention is applied;

FIG. 2B is a view illustrating an example of a traveling scene following the traveling scene in FIG. 2A;

FIG. 2C is a view illustrating an example of a traveling scene following the traveling scene in FIG. 2B;

FIG. 3 is a block diagram illustrating a configuration of a substantial part of the division line recognition apparatus according to the embodiment of the invention;

FIG. 4A is a view illustrating another example of a traveling scene to which the division line recognition apparatus according to the embodiment of the invention is applied;

FIG. 4B is a view illustrating an example of a traveling scene following the traveling scene in FIG. 4A;

FIG. 5 is a view illustrating further example of a traveling scene to which the division line recognition apparatus according to the embodiment of the invention is applied; and

FIG. 6 is a flowchart illustrating an example of processing executed by a controller in FIG. 3.

### DETAILED DESCRIPTION OF THE INVENTION

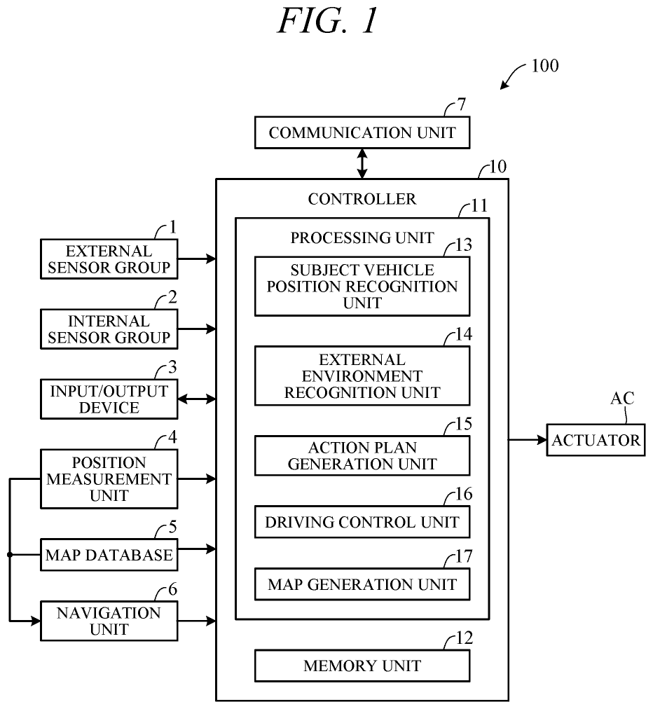

Hereinafter, an embodiment of the present invention is explained with reference to FIGS. 1 to 6. A division line recognition apparatus according to an embodiment of the invention is applied to a vehicle having a self-driving capability, i.e., a self-driving vehicle, for example. The self-driving vehicle having the division line recognition apparatus may be sometimes called “subject vehicle” to differentiate it from other vehicles. The subject vehicle is an engine vehicle having an internal combustion engine (engine) as a travel drive source, electric vehicle having a travel motor as the travel drive source, or hybrid vehicle having both of the engine and the travel motor as the travel drive source. The subject vehicle can travel not only in a self-drive mode in which a driving operation by a driver is unnecessary, but also in a manual drive mode in which the driving operation by the driver is necessary.

First, the general configuration of the subject vehicle for self-driving will be explained. FIG. 1 is a block diagram schematically illustrating an overall configuration of a vehicle control system 100 of the subject vehicle having the division line recognition apparatus according to an embodiment of the present invention. As shown in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LIDAR (Light Detection and Ranging) for measuring distance from the subject vehicle to ambient obstacles by measuring scattered light produced by laser light radiated from the subject vehicle in every direction, a RADAR (Radio Detection and Ranging) for detecting other vehicles and obstacles around the subject vehicle by radiating electromagnetic waves and detecting reflected waves, and a CCD, CMOS or other image sensor-equipped on-board cameras for imaging subject vehicle ambience (forward, reward and sideways).

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting forward-rearward direction acceleration and lateral acceleration of the subject vehicle, respectively, rotational speed sensor for detecting rotational speed of the travel drive source, a yaw rate sensor for detecting rotation angle speed around a vertical axis passing center of gravity of the subject vehicle and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a hard disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 35. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information, traffic data and the like, periodically or at arbitrary times. In addition to acquiring travel history information, travel history information of the subject vehicle may be transmitted to the server via the communication unit 7. The networks include not only public wireless communications network, but also closed communications networks, such as wireless LAN, Wi-Fi and

Bluetooth, which are established for a predetermined administrative area. Acquired map data are output to the map database 5 and/or memory unit 12 via the controller 10 to update their stored map data.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for turning the front wheels FW.

The controller 10 is constituted by an electronic control unit (ECU). More specifically, the controller 10 incorporates a computer including a CPU or other processing unit (a microprocessor) 51 for executing a processing in relation to travel control, the memory unit (a memory) 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map data (road map information) for self-driving. The road map information includes information on road position, information on road shape (curvature, etc.), information on gradient of the road, information on position of intersections and branches, information on type and position of division line such as white line, information on the number of lanes, information on width of lane and the position of each lane (center position of lane and boundary line of lane), information on position of landmarks (traffic lights, signs, buildings, etc.) as a mark on the map, and information on the road surface profile such as unevennesses of the road surface, etc. The map information stored in the memory unit 12 includes map information (referred to as external map information) acquired from the outside of the subject vehicle through the communication unit 7, and map information (referred to as internal map information) created by the subject vehicle itself using the detection values of the external sensor group 1 or the detection values of the external sensor group 1 and the internal sensor group 2.

The external map information is, for example, information of a map (called a cloud map) acquired through a cloud server, and the internal map information is information of a map (called an environmental map) consisting of point cloud data generated by mapping using a technique such as SLAM (Simultaneous Localization and Mapping). The external map information is shared by the subject vehicle and other vehicles, whereas the internal map information is unique map information of the subject vehicle (e.g., map information that the subject vehicle has alone). In an area in which no external map information exists, such as a newly established road, an environmental map is created by the subject vehicle itself. The internal map information may be provided to the server or another vehicle via the communication unit 7. The memory unit 12 also stores information such as programs for various controls, and thresholds used in the programs.

As functional configurations in relation to mainly self-driving, the processing unit 11 includes a subject vehicle position recognition unit 13, an external environment recognition unit 14, an action plan generation unit 15, a driving control unit 16, and a map generation unit 17.

The subject vehicle position recognition unit 13 recognizes the position of the subject vehicle (subject vehicle position) on the map based on position information of the subject vehicle calculated by the position measurement unit 4 and map information stored in the map database 5. Optionally, the subject vehicle position can be recognized using map information stored in the memory unit 12 and ambience data of the subject vehicle detected by the external sensor group 1, whereby the subject vehicle position can be recognized with high accuracy. The movement information (movement direction, movement distance) of the subject vehicle is calculated based on the detection value of the internal sensor group 2, thereby it is also possible to recognize the position of the subject vehicle. Optionally, when the subject vehicle position can be measured by sensors installed externally on the road or by the roadside, the subject vehicle position can be recognized with high accuracy by communicating with such sensors through the communication unit 7.

The external environment recognition unit 14 recognizes external circumstances around the subject vehicle based on signals from cameras, LIDERs, RADARs and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road division lines (white lines, etc.) and stop lines, buildings, guardrails, power poles, commercial signs, pedestrians, bicycles, and the like. Recognized states of other objects include, for example, traffic light color (red, green or yellow) and moving speed and direction of pedestrians and bicycles. A part of a stationary object among other objects, constitutes a landmark serving as an index of position on the map, and the external environment recognition unit 14 also recognizes the position and type of the landmark.

The action plan generation unit 15 generates a driving path (target path) of the subject vehicle from present time point to a certain time ahead based on, for example, a target route computed by the navigation unit 6, map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. An action plan is also called “travel plan”. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

The map generation unit 17 generates the environment map constituted by three-dimensional point cloud data using detection values detected by the external sensor group 1 during traveling in the manual drive mode. Specifically, an edge indicating an outline of an object is extracted from a camera image acquired by the camera based on luminance and color information for each pixel, and a feature point is extracted using the edge information. The feature point is, for example, an intersection of the edges, and corresponds to a corner of a building, a corner of a road sign, or the like. The map generation unit 17 calculates the distance to the extracted feature point and sequentially plots the feature point on the environment map, thereby generating the environment map around the road on which the subject vehicle has traveled. The environment map may be generated by extracting the feature point of an object around the subject vehicle using data acquired by radar or LIDAR instead of the camera.

The subject vehicle position recognition unit 13 performs subject vehicle position estimation processing in parallel with map creation processing by the map generation unit 17. That is, the position of the subject vehicle is estimated based on a change in the position of the feature point over time. The map creation processing and the position estimation processing are simultaneously performed, for example, according to an algorithm of SLAM. The map generation unit 17 can generate the environment map not only when the vehicle travels in the manual drive mode but also when the vehicle travels in the self-drive mode. If the environment map has already been generated and stored in the memory unit 12, the map generation unit 17 may update the environment map with a newly obtained feature point.

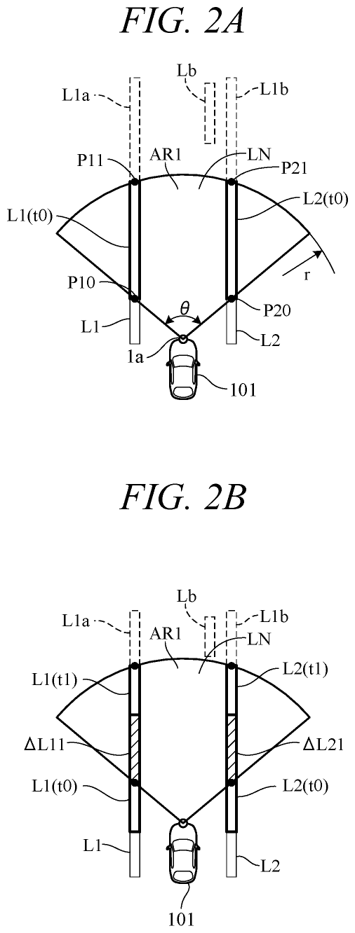

A configuration of the division line recognition apparatus according to the present embodiment will be described. FIG. 2A is a view illustrating an example of a traveling scene to which the division line recognition apparatus 50 is applied, and illustrates a scene in which the subject vehicle 101 travels in the manual drive mode while generating the environment map, that is, travels on a lane LN defined by left and right lines L1 and L2. As illustrated in FIG. 2A, a camera 1a is mounted on a front portion of the subject vehicle 101. The camera 1a has a unique viewing angle θ and a maximum detection distance r determined by performance of the camera itself. The inside of a fan-shaped range AR1 having a radius r and a central angle θ centered on the camera 1a is a range of an external space detectable by the camera 1a, that is, a detectable area AR1. The detectable area AR1 includes, for example, a plurality of division lines (for example, white lines) L1 and L2. When a part of the viewing angle of the camera 1a is blocked by the presence of a component arranged around the camera 1a, the detectable area AR1 is determined in consideration of this.

Intersections P10, P11, P20, and P21 between the fan-shaped boundary line indicating the detectable area AR1 and the division lines L1 and L2 are limit points determined by the detection performance of the camera itself. Therefore, it is possible to detect the division line L1 in the area from the limit point P10 to the limit point P11 and the division line L2 in the area from the limit point P20 to the limit point P21 by extracting the edge points from the camera image. FIG. 2A is an example of a traveling scene at an initial time point T0, and division lines detected at the initial time point TO, that is, the division lines L1 and L2 (thick lines) formed by linear figures surrounded by the edges are represented as L1 (t0) and L2 (t0). The division lines L1a and L2a (dotted lines) on the extension of the division lines L1 (t0) and L2 (t0) in FIG. 2A are unfinalized division lines that have not yet been detected by the camera 1a at the time point T0.

Incidentally, there may be an area where a crack forms on the road surface. In addition, division lines marked on the road surface may be redrawn, and in this case, a part of old division lines before redrawing may remain. Such road surface cracks or division lines before redrawing are a linear figure different from a normal division line, and hereinafter, these are referred to as a non-division line. FIG. 2A illustrates an example of a linear non-division line Lb (dotted line) located on the lane LN in front of the subject vehicle 101. If the non-division line Lb is linear, the controller 10 may erroneously recognize the non-division line Lb as a division line. Then, in order to prevent erroneous recognition of the division line, the division line recognition apparatus is configured as follows in the present embodiment:

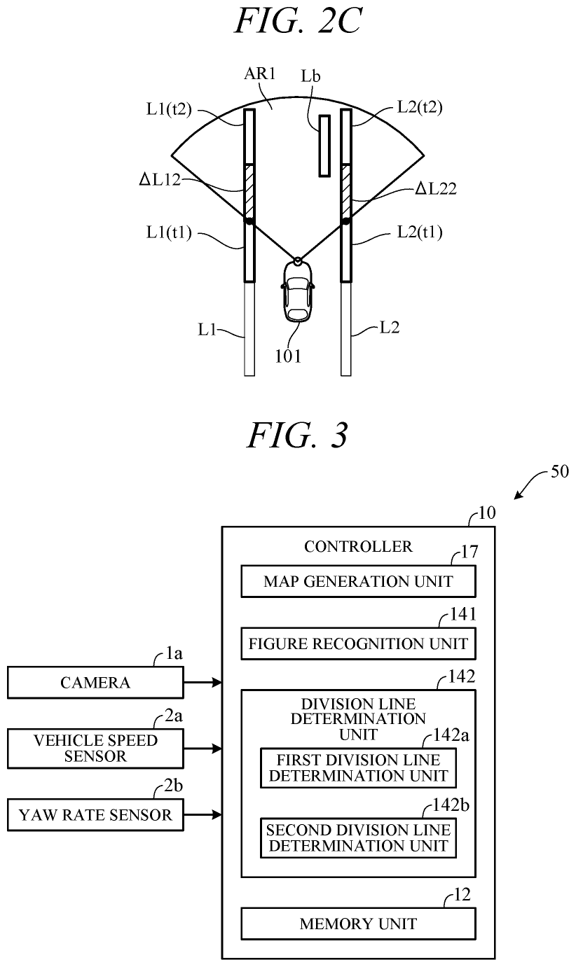

FIG. 3 is a block diagram illustrating a configuration of a substantial part of the division line recognition apparatus 50 according to the present embodiment. The division line recognition apparatus 50 constitutes a part of the vehicle control system 100 in FIG. 1. As illustrated in FIG. 3, the division line recognition apparatus 50 includes the controller 10, the camera 1a, the vehicle speed sensor 2a, and the yaw rate sensor 2b.

The camera 1a is a monocular camera having an imaging element (image sensor) such as a CCD or a CMOS, and constitutes a part of the external sensor group 1 in FIG. 1. The camera 1a may be a stereo camera. The camera 1a is mounted at a predetermined position, for example, in front of the subject vehicle 101 (FIG. 2A), and continuously captures an image of a space in front of the subject vehicle 101 to acquire an image (camera image) of an object. The object includes a division line (for example, the division lines L1 and L2 in FIG. 2A) on the road. The object may be detected by a LIDAR or the like instead of the camera 1a or together with the camera 1a.

The vehicle speed sensor 2a and the yaw rate sensor 2b are a part of the internal sensor group 2, and are used to calculate the movement amount and the movement direction of the subject vehicle 101. That is, the controller 10 (for example, the subject vehicle position recognition unit 13 in FIG. 1) calculates the movement amount of the subject vehicle 101 by integrating the vehicle speed detected by the vehicle speed sensor 2a, calculates the yaw angle by integrating the yaw rate detected by the yaw rate sensor 2b, and estimates the position of the subject vehicle 101 by odometry. For example, the subject vehicle position is estimated by odometry when the environment map is created during traveling in the manual drive mode. The self-position may be estimated using information from other sensors.

The controller 10 in FIG. 3 includes a figure recognition unit 141 and a division line determination unit 142 in addition to the map generation unit 17 as a functional configuration undertaken by the processing unit 11 (FIG. 1). The figure recognition unit 141 and the division line determination unit 142 have a function to recognize the external environment and constitute a part of the external environment recognition unit 14 in FIG. 1. Since the figure recognition unit 141 and the division line determination unit 142 also have a map generation function, all or a part of them may be included in the map generation unit 17.

The map generation unit 17 generates the environment map by extracting the feature point of the object around the subject vehicle 101 based on the camera image acquired by the camera 1a during traveling in the manual drive mode. The generated environment map is stored in the memory unit 12. The map generation unit 17 recognizes the position of the division line determined as a division line by the division line determination unit 142 as described later, and includes the information on the division line in the map information (for example, the internal map information) and stores the map information. The recognized division line is a division line within the detectable area AR1 of the camera 1a. The stored division line information includes information about the color (white or yellow) and the type (solid line or broken line) of the division line.

The figure recognition unit 141 recognizes a linear figure on the road surface based on the camera image acquired by the camera 1a. More specifically, an edge point at which a change in luminance and color for each pixel is equal to or greater than a predetermined value is extracted from the camera image and a linear figure obtained by plotting the extracted edge point on the environment map is recognized. The linear figure includes the division lines L1 and L2 and the non-division line Lb in FIG. 2A. The recognition of the linear figure by the figure recognition unit 141 is performed every predetermined time Δt, that is, at a predetermined cycle.

FIG. 2B illustrates the traveling scene at a first time point T1 after the predetermined time Δt elapses from the initial time point T0 in FIG. 2A, and FIG. 2C illustrates the traveling scene at a second time point T2 after the predetermined time Δt elapses from the first time point T1 in FIG. 2B. As illustrated in FIGS. 2B and 2C, the detectable area AR1 also moves as the subject vehicle 101 moves. As illustrated in FIG. 2B, the detectable area AR1 includes the division lines L1 (t1) and L2 (t1) at the first time point T1, and the detectable area AR1 includes the division lines L1 (t2) and L2 (t2) and the non-division line Lb at the second time point T2. The figure recognition unit 141 recognizes the linear figure (the division line or the non-division line) at each of the time points T0, T1, and T2.

The division line determination unit 142 determines whether the linear figure recognized by the figure recognition unit 141 constitutes the division line L1 or L2, or the non-division line Lb. The division line determination unit 142 includes a first division line determination unit 142a and a second division line determination unit 142b that recognize the division line in different modes from each other.

The first division line determination unit 142a determines whether or not the linear figure recognized by the figure recognition unit 141 is continuous between two consecutive time points. When it is determined that the figure is continuous, the recognized linear figure is determined as a division line. When it is determined that the figure is not continuous, the recognized linear figure is determined as a non-division line. Specifically, as illustrated in FIG. 2B, when it is determined that the linear figure (the division lines L1 (t1) and L2 (t1)) recognized at the first time point T1 is continuous with the linear figure (the division lines L1 (t0) and L2 (t0)) recognized at the immediately preceding initial time point T0, it is determined that the linear figure recognized at the first time point T1 is the division lines L1 and L2.

In addition, as illustrated in FIG. 2C, when it is determined that the linear figure (the division line L1 (t2) or L2 (t2)) recognized at the second time point T2 is continuous with the linear figure (the division line L1 (t1) or L2 (t1)) recognized at the immediately preceding initial time point T1, it is determined that the linear figure recognized at the second time point T2 is the division line L1 or L2. The hatching areas ΔL11 and ΔL21 in FIG. 2B indicate areas where the division lines L1 (t0) and L2 (t0) at the initial time point T0 and the division lines L1 (t1) and L2 (t1) at the first time point T1 overlap with each other, and the hatching areas ΔL12 and ΔL22 in FIG. 2C indicate areas where the division lines L1 (t1) and L2 (t2) at the first time point T1 and the division lines L1 (t2) and L2 (t2) at the second time point T2 overlap with each other.

The state in which the linear figure is continuous refers to the state in which, as indicated by the hatching areas ΔL11, ΔL21, ΔL12, and ΔL22, the positions of a part of the linear figures between the consecutive time points overlap with each other, that is, the positions of the edge points indicating the boundaries of the division lines L1 and L2 have the length that is equal to or more than a predetermined length over the length direction of the division lines L1 and L2 and continuously coincide with each other. The coincidence in this case is not a coincidence in a strict sense and it is merely required that, for example, the positional displacement amount of the linear figure in the lane width direction be within a predetermined value (for example, about several cm). When the linear figure Lb recognized at the second time point T2 is not recognized at the first time point T1, since the linear figure Lb is not continuous between the two consecutive time points T1 and T2, the first division line determination unit 142a determines that the linear figure Lb (FIG. 2C) is a non-division line.

There are cases where the overlap of the linear figures is not recognized due to, for example, a long time interval for recognizing the linear figures (the predetermined time Δt). In this case, a determination may be made on whether or not there is an overlap between an extension line obtained by extending the division lines L1 and L2 already recognized and the linear figure recognized within the detectable area AR1, and a determination may be made on whether or not the linear figure is a division line based on the above determination.

When determining whether or not the linear figure is a division line, the first division line determination unit 142a estimates the self-position based on signals from the vehicle speed sensor 2a and the yaw rate sensor 2b. Then, using the estimation result, the recognized linear figure is plotted on the environment map and the continuity of the linear figure is determined. This makes it possible to accurately determine the continuity of the division line even when the subject vehicle 101 traveling in the center of the lane LN approaches the side of one of the division lines L1 and L2.

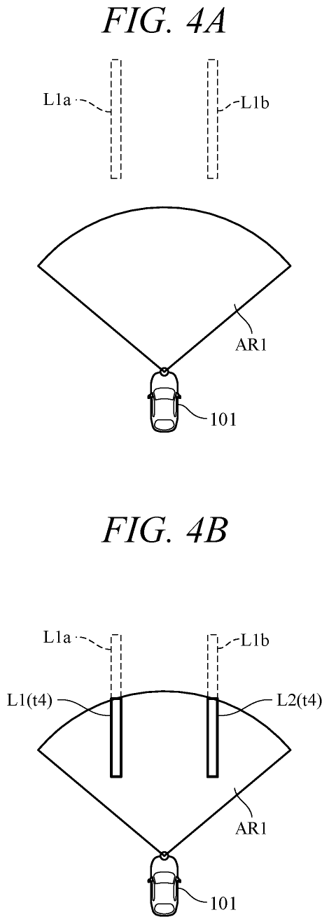

FIGS. 4A and 4B are views illustrating an example of a traveling scene other than that in FIGS. 2A to 2C. In particular, FIG. 4A illustrates the traveling scene at a third time point T3, and FIG. 4B illustrates the traveling scene at a fourth time point T4 after the predetermined time Δt elapses from the third time point T3. In FIG. 4A, the linear figure is not recognized in the detectable area AR1 by the camera 1a, and the division line determination unit 142 determines that there is no division line at the time point T3. Thereafter, as illustrated in FIG. 4B, when the linear figure is recognized in the detectable area AR1 at the time point T4, the division line determination unit 142 recognizes that the linear figures are the division lines L1 (t4) and L2 (t4). That is, when it is determined that there is no division line at the immediately preceding time point T3, the first division line determination unit 142a determines the linear figure as a division line without making a determination on the continuity of the linear figure even if there is no continuity of the linear figure.

When the first division line determination unit 142a determines that the linear figure is a division line through the processing described above, the map generation unit 17 incorporates the division line information into the map information and stores the map information in the memory unit 12. As a result, the subject vehicle 101 can identify the position of the traveling lane LN defined by the division lines L1 and L2 while the subject vehicle position is recognized by the subject vehicle position recognition unit 13 (FIG. 1).

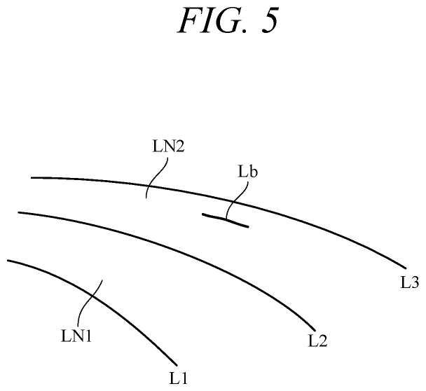

The second division line determination unit 142b recognizes a lane (a current lane) on which the subject vehicle 101 travels based on the map information (the division line information) stored in the memory unit 12, for example, during traveling in the self-drive mode. Further, another lane adjacent to the current lane is recognized. FIG. 5 is a view illustrating an example of the recognized current lane LN1 and the other lane LN2. In FIG. 5, the current lane LN1 is defined by the division lines L1 and L2, and the other lane LN2 is defined by the division lines L2 and L3. A technique such as segmentation DNN (Deep Neural Network) can be used to recognize the current lane LN1 and the other lane LN2.

The second division line determination unit 142b determines whether or not a linear figure has been recognized by the figure recognition unit 141 in the recognized current lane LN1 or other lane LN2 based on the camera image. Then, when the linear figure is recognized, it is determined that the linear figure is a non-division line, and the linear figure is not included in the division line information and is ignored. For example, as illustrated in FIG. 5, the linear figure on the other lane LN2 is determined as the non-division line Lb. The linear figure in the lanes LN1 and LN2 is discontinuous. Therefore, the determination on whether or not there is a linear figure in the lanes LN1 and LN2 is also made based on the continuity of the linear figure.

The second division line determination unit 142b may be configured to recognize (predict) an area occupied by the lanes LN1 and LN2 and the division lines L1 to L3 around the area using a method such as segmentation DNN while generating the environment map during traveling in the manual drive mode, and to, when a linear figure is recognized within the lane, determine that the linear figure is a non-division line. With this configuration, the second division line determination unit 142b can distinguish the non-division line Lb from the division lines L1 to L3 after predicting the lane area during traveling based on the camera image without using the division line information stored in memory unit 12.

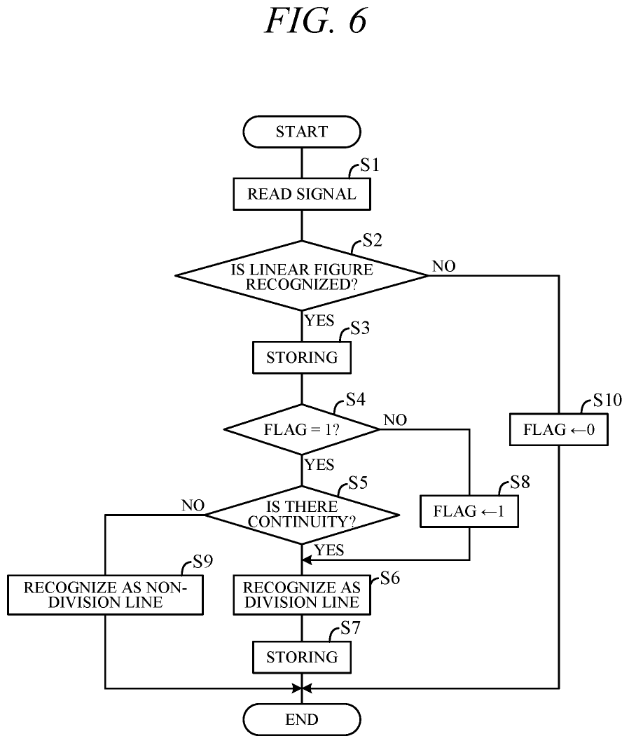

FIG. 6 is a flowchart illustrating an example of processing executed by the controller 10 in FIG. 3 according to a predetermined program. The processing illustrated in this flowchart shows processing mainly at the first division line determination unit 142a, and is started, for example, in the manual drive mode and is repeated at a predetermined cycle. For processing at the second division line determination unit 142b, descriptions in the flowchart are omitted.

As illustrated in FIG. 6, first in S1 (S: processing step), signals from the camera la, the vehicle speed sensor 2a, and the yaw rate sensor 2b are read. Next, in S2, it is determined whether or not a linear figure has been recognized within the detectable area AR1 on the road surface based on the camera image. When a positive determination is made in S2, the processing proceeds to S3; when a negative determination is made, the flag is set to 0 in S10 and the processing ends. The flag indicates whether or not the linear figure has been recognized, and in this case, the flag is set to 0.

In S3, the recognized linear figure is temporarily stored in the memory unit 12. Next, in S4, it is determined whether or not the flag is 1. The flag is 0 when the linear figure is not recognized in the previous processing. In this case, a negative determination is made in S4 and the processing proceeds to S8, and the flag is set to 1 and the processing proceeds to S6.

Meanwhile, when a positive determination is made in S4, the processing proceeds to S5, and it is determined whether or not the linear figure recognized in the previous processing and the linear figure recognized in the current processing are continuous. When a positive determination is made in S5, the processing proceeds to S6, and the linear figure recognized in S2 is recognized as a division line. Next, in S7, information on the recognized division line is stored in the memory unit 12 as a part of the map information, and the processing ends. Meanwhile, when a negative determination is made in S5, the processing proceeds to S9, and the linear figure recognized in S2 is recognized as a non-division line and the processing ends.

The operation of the division line recognition apparatus 50 according to the present embodiment is summarized as follows. The scene in which the subject vehicle 101 travels in the manual drive mode while creating the environment map based on the camera image is assumed. At this time, when the linear figures (L1 (t1) and L2 (t1)) are recognized as illustrated in FIG. 2B after the linear figures (L1 (t0) and L2 (t0)) are recognized as illustrated in FIG. 2A, since parts (ΔL11 and ΔL21) of the linear figures are overlapped and continuous, the linear figures (L1 (t1) and L2 (t1)) are recognized as the division lines L1 and L2 (S6). Thereafter, when the linear figures (L1 (t2) and L2 (t2)) are recognized as illustrated in FIG. 2C, since parts (ΔL12 and ΔL22) of the linear figures are overlapped and continuous, the linear figures (L1 (t2) and L2 (t2)) are also recognized as the division lines L1 and L2 (S6).

On the other hand, since the linear figure Lb in FIG. 2C has not been recognized in the previous processing, the linear figure Lb has no continuity and is recognized as a non-division line (S9). With this operation, it is possible to prevent a linear figure generated by a crack or the like on the road surface from being erroneously recognized as a division line. Therefore, it is possible to accurately recognize the division line and satisfactorily perform traveling in the self-drive mode using the division line information.

During traveling in the self-drive mode, the current lane LN1 and the other lane LN2 are recognized based on the camera image. At this time, as illustrated in FIG. 5, when the linear figure Lb is recognized within the area of the other lane LN2, the linear figure Lb is ignored as a non-division line. With this operation, it is possible to perform stable traveling in the self-drive mode even when the linear figure due to the crack or the like is recognized during traveling in the self-drive mode.

The present embodiment can achieve advantages and effects such as the following:

(1) The division line recognition apparatus 50 includes the camera 1a that detects the external situation around the subject vehicle 101, the figure recognition unit 141 that recognizes the linear figure on the road surface based on the external situation detected by the camera 1a, and the division line determination unit 142 that determines whether or not the linear figure is the division line L1 or L2 that defines the lane LN based on the continuity of the linear figure recognized by the figure recognition unit 141 (FIG. 3). This makes it possible to accurately recognize the division lines L1 and L2 on the road surface and prevent a crack of the road surface and an old division line before the division line is redrawn from being erroneously recognized as a normal division line.

(2) The figure recognition unit 141 recognizes the linear figure on the road surface between two consecutive time points, that is, between the initial time point TO and the first time point T1 and between the first time point T1 and the second time point T2 (FIGS. 2A to 2C). The division line determination unit 142 (the first division line determination unit 142a) determines whether or not the linear figure recognized at the time point T0 or T1 and the linear figure recognized at the subsequent time point T1 or T2 are continuous, and when it is determined that they are continuous, determines that the recognized linear figure is a division line (FIG. 6). This makes it possible to obtain highly accurate division line information while generating the environment map.

(3) The division line recognition apparatus 50 includes the vehicle speed sensor 2a and the yaw rate sensor 2b for recognizing the position of the subject vehicle 101 by odometry as the subject vehicle position recognition unit 13 (FIGS. 1 and 3). The division line determination unit 142 (the first division line determination unit 142a) determines whether the linear figures recognized at the two consecutive time points are continuous based on the position change of the subject vehicle 101 recognized by the subject vehicle position recognition unit 13 (FIG. 6). This makes it possible to accurately distinguish the division line from the non-division line even when the subject vehicle 101 traveling in the center of the lane LN approaches the side of one of the division lines L1 and L2 because the continuity of the linear figure is determined in consideration of the position change of the subject vehicle 101.

(4) The division line recognition apparatus 50 further includes the memory unit 12 that stores information on the division line determined as a division line by the division line determination unit 142 (FIG. 3). When the linear figure Lb is recognized by the figure recognition unit 141 inside the lane LN2 defined by the division line stored in the memory unit 12, the division line determination unit 142 (the second division line determination unit 142b) determines that the recognized linear figure Lb is not a division line (FIG. 5). This makes it possible to appropriately continue traveling in the self-drive mode when the linear figure is recognized during traveling in the self-drive mode on the road whose division line information has been stored.

The above embodiment may be modified into various forms. Hereinafter, some modifications will be described. In the above embodiment, the external situation around the subject vehicle is detected by the external sensor group 1 such as the camera 1a; however, a detection part (detection device) other than the camera 1a such as LIDAR may be used as long as the detection part is configured to be able to detect the linear figure on the road surface. In the above embodiment, the linear figure on the road surface is continuously recognized based on the camera image; however, the configuration of a figure recognition unit is not limited thereto.

In the above embodiment, the first division line determination unit 142a determines whether the linear figures (a first linear figure and a second linear figure) recognized at the two consecutive time points (a first time point and a second time point) are continuous, and the second division line determination unit 142b determines whether the linear figure is recognized in the area inside the recognized lane LN. That is, a determination is made on whether or not the linear figure is the division line L1, L2, or

L3 that defines the lane LN based on the continuity of the linear figure recognized by the figure recognition unit 141; however, the configuration of a division line determination unit is not limited to that described above. For example, a determination may be made on not only whether or not the linear figures recognized at the two time points are continuous but also whether or not the linear figures are continuous for a predetermined length or more, and a determination may be made that the linear figures are a division line when the linear figures are continuous for the predetermined length or more.

The present invention can also be used as a division line recognition method including recognizing a linear figure on a road surface, based on an external situation around a subject vehicle detected by a detection part, and determining whether the linear figure is a division line defining a lane, based on a continuity of the linear figure recognized in the recognizing.

The above embodiment can be combined as desired with one or more of the above modifications. The modifications can also be combined with one another.

According to the present invention, it is possible to prevent a false recognition that an actual division line is broken when a broken division line is detected, even though the division line is not actually broken.

Above, while the present invention has been described with reference to the preferred embodiments thereof, it will be understood, by those skilled in the art, that various changes and modifications may be made thereto without departing from the scope of the appended claims.

What is claimed is:

1. A division line recognition apparatus, comprising:
a detection part configured to detect an external situation around a subject vehicle; and
an electronic control unit including a microprocessor and a memory connected to the microprocessor, wherein the microprocessor is configured to perform:
recognizing a linear figure on a road surface, based on the external situation detected by the detection part; and
determining whether the linear figure is a division line defining a lane, based on a continuity of the linear figure recognized.

2. The division line recognition apparatus according to claim 1, wherein the microprocessor is configured to perform the recognizing including recognizing the linear figure on the road surface at a first time point and a second time point continuous to the first time point, the linear figure recognized at the first time point is a first linear figure, and the linear figure recognized at the second time point is a second linear figure, and the microprocessor is configured to perform the determining including determining whether the first linear figure and the second linear figure are continuous, and when it is determined that the first linear figure and the second linear figure are continuous, determining that the linear figure recognized is the division line.

3. The division line recognition apparatus according to claim 2, wherein the microprocessor is configured to further perform recognizing a position of a subject vehicle, and the determining including determining whether the first linear figure and the second linear figure are continuous, based on a change of the position of the subject vehicle.

4. The division line recognition apparatus according to claim 3, wherein
the microprocessor is configured to further perform
generating a map including a division line information, based on the external situation detected by the detection part, and
the microprocessor is configured to perform
the determining including determining whether the first linear figure and the second linear figure are continuous by plotting the linear figure on the map with respect to the position of the subject vehicle recognized.

5. The division line recognition apparatus according to claim 2, wherein
the microprocessor is configured to perform
the determining including determining whether an extension line obtained by extending the first linear figure recognized at the first time point and the second linear figure recognized at the second time point are continuous, and when it is determined that the extension line and the second linear figure are continuous, determining that the linear figure recognized is the division line.

6. The division line recognition apparatus according to claim 1, wherein
the memory unit is configured to store an information on the division line determined as the division line defining the lane, and
the microprocessor is configured to perform
the determining including determining that the linear figure recognized is not the division line, when the linear figure is recognized inside the lane defined by the division line stored in the memory unit.

7. A division line recognition apparatus, comprising:
a detection part configured to detect an external situation around a subject vehicle; and
an electronic control unit including a microprocessor and a memory connected to the microprocessor, wherein
the microprocessor is configured to function as:
a figure recognition unit that recognizes a linear figure on a road surface, based on the external situation detected by the detection part; and
a division line determination unit that determines whether the linear figure is a division line defining a lane, based on a continuity of the linear figure recognized by the figure recognition unit.

8. The division line recognition apparatus according to claim 7, wherein
the figure recognition unit recognizes the linear figure on the road surface at a first time point and a second time point continuous to the first time point,
the linear figure recognized at the first time point is a first linear figure and, the linear figure recognized at the second time point is a second linear figure, and
the division line determination unit determines whether the first linear figure and the second linear figure are continuous, and when it is determined that the first linear figure and the second linear figure are continuous, determines that the linear figure recognized by the figure recognition unit is the division line.

9. The division line recognition apparatus according to claim 8, wherein
the microprocessor is configured to further function as
a subject vehicle position recognition unit that recognizes a position of a subject vehicle, and
the division line determination unit determines whether the first linear figure and the second linear figure are continuous, based on a change of the position of the subject vehicle recognized by the subject vehicle position recognition unit.

10. The division line recognition apparatus according to claim 9, wherein
the microprocessor is configured to further function as
a map generation unit that generates a map including a division line information, based on the external situation detected by the detection part, and
the division line determination unit determines whether the first linear figure and the second linear figure are continuous by plotting the linear figure recognized by the figure recognition unit on the map generated by the map generation unit with respect to the position of the subject vehicle recognized by the subject vehicle position recognition unit.

11. The division line recognition apparatus according to claim 8, wherein
the division line determination unit determines whether an extension line obtained by extending the first linear figure recognized at the first time point and the second linear figure recognized at the second time point are continuous, and when it is determined that the extension line and the second linear figure are continuous, determines that the linear figure recognized by the figure recognition unit is the division line.

12. The division line recognition apparatus according to claim 7, wherein
the memory unit is configured to store an information on the division line determined as the division line defining the lane, and
the division line determination unit determines that the linear figure recognized by the figure recognition unit is not the division line, when the linear figure is recognized by the figure recognition unit, inside the lane defined by the division line stored in the memory unit.

13. A division line recognition method, comprising:
recognizing a linear figure on a road surface, based on an external situation around a subject vehicle detected by a detection part; and
determining whether the linear figure is a division line defining a lane, based on a continuity of the linear figure recognized in the recognizing.

14. The division line recognition method according to claim 13, wherein
the recognizing includes recognizing the linear figure on the road surface at a first time point and a second time point continuous to the first time point,
the linear figure recognized at the first time point is a first linear figure and, the linear figure recognized at the second time point is a second linear figure, and
the determining includes determining whether the first linear figure and the second linear figure are continuous, and when it is determined that the first linear figure and the second linear figure are continuous, determining that the linear figure recognized in the recognizing is the division line.

15. The division line recognition method according to claim 14, further comprising
recognizing a position of a subject vehicle, wherein
the determining includes determining whether the first linear figure and the second linear figure are continuous, based on a change of the position of the subject vehicle.

16. The division line recognition method according to claim 15, further comprising
generating a map including a division line information, based on the external situation detected by the detection part, wherein
the determining includes determining whether the first linear figure and the second linear figure are continuous by plotting the linear figure recognized in the recognizing on the map with respect to the position of the subject vehicle.

17. The division line recognition method according to claim 14, wherein
the determining includes determining whether an extension line obtained by extending the first linear figure recognized at the first time point and the second linear figure recognized at the second time point are continuous, and when it is determined that the extension line and the second linear figure are continuous, determining that the linear figure recognized in the recognizing is the division line.

18. The division line recognition method according to claim 13, further comprising
storing in a memory unit an information on the division line determined as the division line defining the lane, wherein
the determining includes determining that the linear figure recognized in the recognizing is not the division line, when the linear figure is recognized, inside the lane defined by the division line stored in the memory unit.
